(19) United States
(12) Patent Application Publication
(10) Pub. No.: US 2009/0157442 A1
(43) Pub. Date: Jun. 18, 2009

(54) System and Method for Improving the Performance of Digital Advertisements

(75) Inventor: Lawrence G. Tesler, Portola Valley, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/955,841

(22) Filed: Dec. 13, 2007

(51) Int. Cl. G06Q 30/00

(52) U.S. Cl. 705/7; 705/14

(57) ABSTRACT

Systems and methods for optimizing performance of an ad campaign are disclosed. Generally, an offer is extended to an advertiser to optimize an ad campaign of the advertiser. The offer provides that an optimized version of the ad campaign performs at least as well as an unoptimized version of the ad campaign. Upon acceptance of the offer, an ad campaign optimizer automatically creates an optimized version of an ad campaign and monitors a performance of the optimized version of the ad campaign and the unoptimized version of the ad campaign. The ad campaign optimizer then automatically adjusts a portion of ad campaign activations allocated to the optimized ad campaign and a portion of ad campaign activations allocated to the unoptimized ad campaign based on the monitored performance of the optimized ad campaign and the monitored performance of the unoptimized ad campaign.

### BACKGROUND

Internet advertising delivery companies (“sad providers”) such as Yahoo! Inc. (www.yahoo.com) typically sell webpage advertisement placements for the placement of digital ads. An advertiser may purchase a placement for a digital ad based on factors such as what type of devices will receive a digital ad; what webpages will receive a digital ad; where a digital ad will be displayed in a webpage; properties such as demographics, past behaviors, or inferred or declared interests associated with users targeted by a digital ad; what specific digital ads of an ad campaign may be personalized to specific users; and what search query terms, viewed or user-supplied content, or declared or inferred interests of a user cause the ad provider to serve a digital ad. Ad providers and other third-party entities typically provide ad campaign optimizers to allow an ad campaign management system to automatically adjust parameters of an ad campaign, such as the above-listed factors associated with a placement of a digital ad.

### BRIEF DESCRIPTION OF THE DRAWINGS

FIG. 1 is a block diagram of an environment in which a system for improving the performance of digital ads may operate;

FIG. 2 is a block diagram of a system for improving the performance of digital ads; and

FIGS. 3a and 3b are a flow chart of a method for improving the performance of digital ads.

### DETAILED DESCRIPTION OF THE DRAWINGS

The present disclosure is directed to systems and methods for improving the performance of digital advertisements. To encourage an advertiser to utilize an ad campaign optimizer, an ad provider or other third-party entity extends an offer to an advertiser such as to guarantee an ad campaign optimized by an ad campaign optimizer performs at least as well as an unoptimized ad campaign. When an optimized ad campaign performs better than an unoptimized ad campaign, the advertiser may compensate the ad provider, or entity providing ad campaign optimization, based on a difference in performance between the optimized and the unoptimized ad campaigns. If the optimized ad campaign does not perform as well as the unoptimized ad campaign, the ad provider, or entity providing ad campaign optimization, may compensate the advertiser based on a difference in performance between the optimized and the unoptimized ad campaigns.

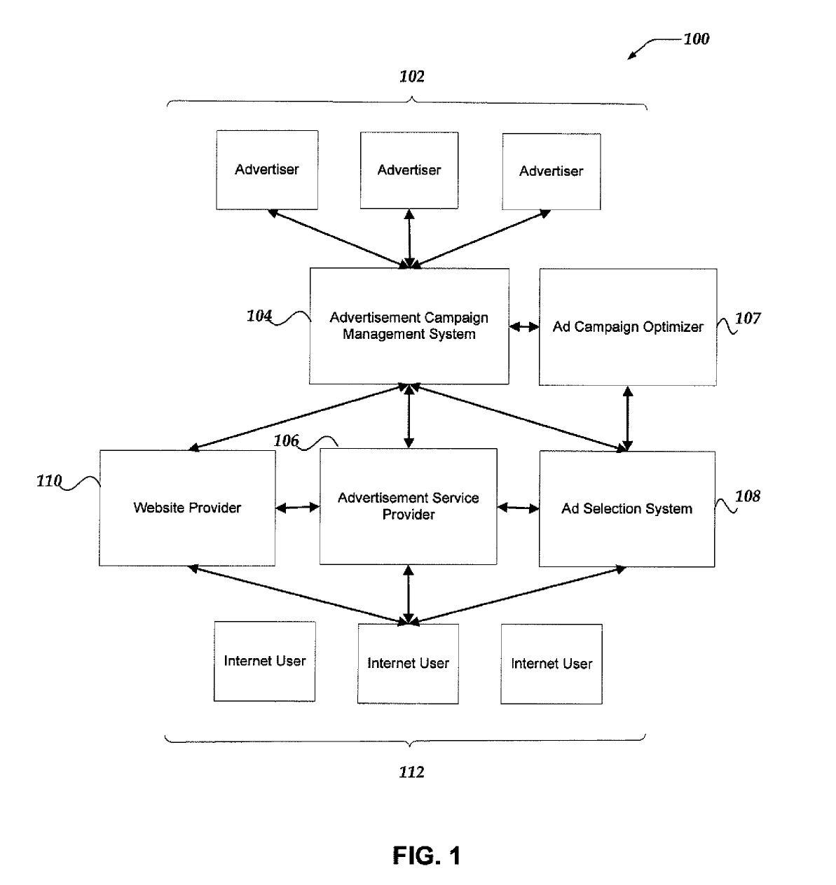

FIG. 1 is a block diagram of an environment in which a system for improving the performance of a digital advertisement may operate. The environment 100 may include a plurality of advertisers 102, an ad campaign management system 104, an ad provider 106, an ad campaign optimizer 107, an ad selection system 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad or any other procurement model known in the art. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by Internet users 112, a sponsored search listing that is served to an Internet user 112 in response to a search performed at a search engine, a video ad, a graphical banner ad based on a sponsored search listing, and/or any other type of online marketing media known in the art.

When an Internet user 112 views a website served by the website provider 110, the ad provider 106 may serve one or more digital ads to the Internet user 112 based on digital ads selected by the ad selection system 108. Generally, the ad selection system 108, which in some implementations may be part of the ad provider 106, selects one or more digital ads to serve to the Internet user 112 based on factors such as a type of device that will receive the digital ad; the specific webpage that will display the digital ad; the location in the webpage where the digital ad will be displayed; properties such as demographics, past behaviors, or inferred or declared interests associated with the Internet user 112; where the Internet user 112 is currently located; a time of day; terms within a search query; and/or a keyword or image present in the content of the webpage where the digital ad will be displayed.

When the digital ads are served, the ad campaign management system 104 and/or the ad provider 106 may record and process information associated with the served digital ads for purposes such as billing, reporting, or ad campaign optimization. For example, the ad campaign management system 104 and/or the provider 106 may record the factors that caused the ad selection system 108 to select the served digital ads; whether the Internet user 112 clicked on a URL or other link associated with one of the served digital ads; what additional search listings or digital ads were served with each served digital ad; a position of a digital ad when the Internet user 112 clicked on a digital ad; and/or whether the Internet user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. In addition, if the advertiser 102 provides conversion data (subscriptions, sales, etc.) to the ad campaign management system 104 and/or the ad provider 106, then that data may also be recorded and processed. The systems described below for improving the performance of digital advertisements may operate in the environment of FIG. 1.

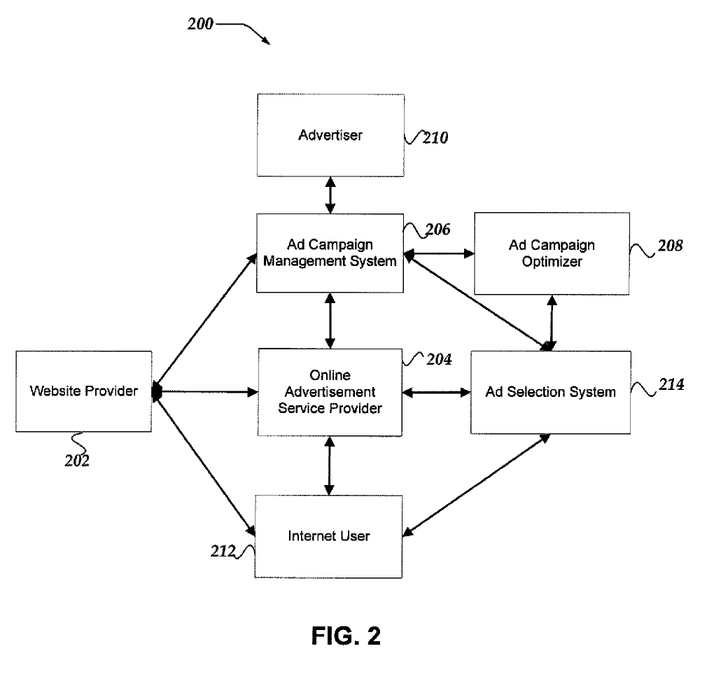

FIG. 2 is a block diagram of one embodiment of a system for improving the performance of digital advertisements. Generally, the system 200 may include a website provider 202, an ad provider 204, an ad campaign management system 206, an ad campaign optimizer 208, and an ad selection system 214.

In some implementations, the ad campaign management system 206, ad campaign optimizer 208, and/or ad selection system 214 may be part of the website provider 202 and/or ad provider 204. However, in other implementations, the ad campaign management system 206, ad campaign optimizer 208, and/or ad selection system 214 are distinct from the website provider 202 and/or ad provider 204.

The website provider 202, ad provider 204, ad campaign management system 206, ad campaign optimizer 208, and ad selection system 214 may communicate with each other over one or more external or internal networks. The networks may include local area networks (LAN), wide area networks (WAN), and the Internet, and may be implemented with wireless or wired communication mediums such as wireless fidelity (WiFi), Bluetooth, landlines, satellites, and/or cellular communications. Further, the website provider 202, ad provider 204, ad campaign management system 206, ad campaign optimizer 208, and ad selection system 214 may be implemented as software code running in a single server, a plurality of servers, or any other type of computing device known in the art.

Generally, an advertiser 210 interacts with the ad campaign management system 206 to create an ad campaign including one or more digital ads such as graphical ads or video ads for placement on a webpage. The ad campaign management system 206 extends an offer to the advertiser 210 to improve the performance of the ad campaigns of the advertiser 210. In some implementations, the ad campaign management system 206 may extend an offer for the ad campaign optimizer 208 to optimize the ad campaigns of the advertiser 210 and guarantee that the performance of the optimized ad campaigns will be at least as good as what the performance of the ad campaigns would have been if the ad campaign optimizer 208 had not optimized the ad campaigns.

If the advertiser 210 accepts the offer, as discussed in more detail below, the ad campaign management system 206 automatically creates an optimized variant of the unoptimized ad campaign. In one implementation, the ad campaign management system 206 creates an optimized variant of an ad campaign by creating an exact copy of the original ad campaign and then applying the optimizer 208 to either the original ad campaign or the copy of the ad campaign, leaving the other ad campaign unchanged. However in other implementations, the ad campaign management system 206 creates an optimized variant of the ad campaign without copying the entire original ad campaign. For example, the ad campaign management system 206 may associate a variable with the campaign that has two possible values, a first value to make the single campaign act as an optimized variant and a second value to make the single campaign act as an unoptimized variant. When the ad selection system 214 chooses a digital ad to run in a particular placement, it bases its choice of ad on optimized parameters of the campaign variant if the variable has the first value, or on unoptimized parameters of the campaign variant if the variable has the second value.

As Internet users 212 interact with webpages, the website provider 202 and/or the ad provider 204 serve digital ads from the optimized ad campaign and the unoptimized ad campaign to the Internet users 210. The website provider 202, ad provider 204, and/or ad campaign management system 206 monitor user activities such as webpage views, interaction with digital ads, views of webpages associated with digital ads and “conversions” (events of material value to the advertiser 210 such as purchases, donations, subscriptions, downloads, uploads, or clicks on other digital ads) associated with the served digital ads to track the performance of the optimized ad campaign and the unoptimized ad campaign. If it is determined that the unoptimized ad campaign performs better than the optimized ad campaign, the ad provider 204 may compensate the advertiser 210 based on the difference in performance between the optimized ad campaign and the unoptimized ad campaign. If it is determined that the optimized ad campaign performs at least as well as the unoptimized ad campaign according to criteria agreed upon by the parties, the ad provider 204 may be compensated based on the difference in performance between the optimized ad campaign and the unoptimized ad campaign.

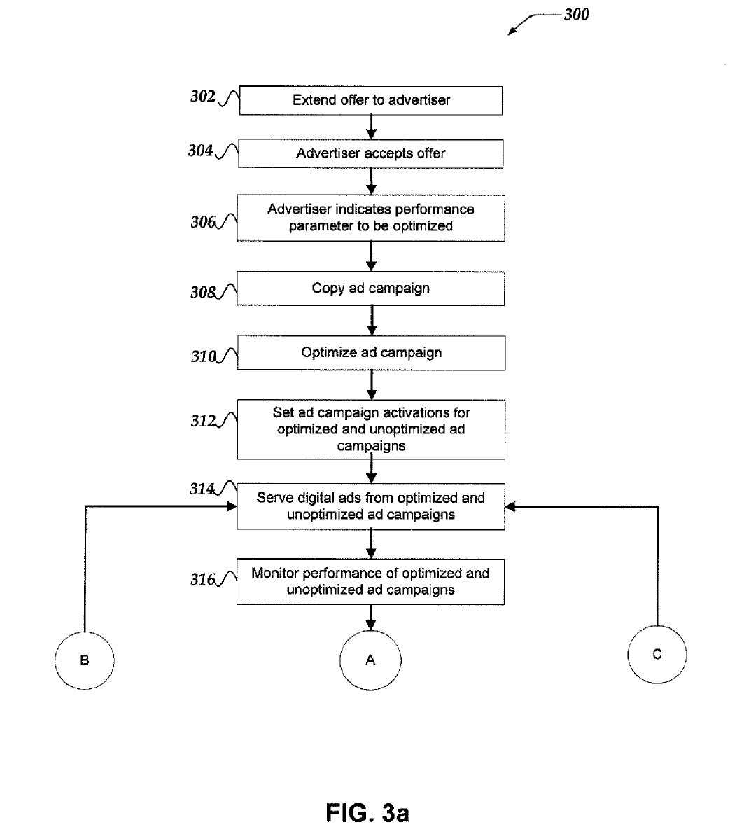

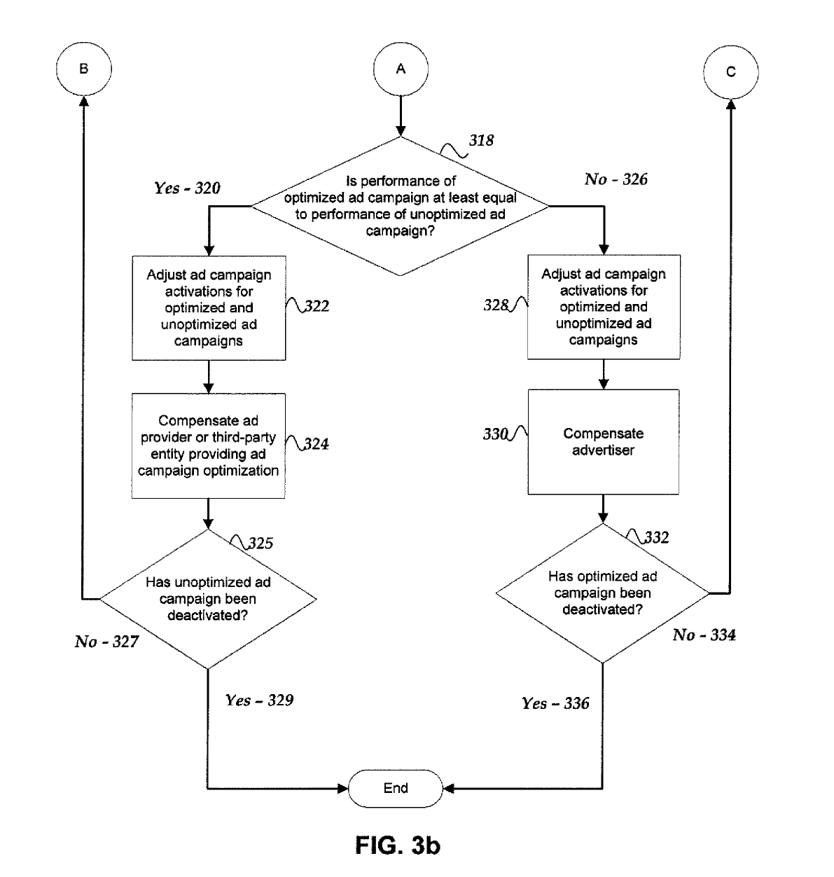

FIGS. 3a and 3b are a flow chart of one embodiment of a method for improving the performance of digital ads. The method 300 begins at step 302 with an ad provider or other third-party entity extending an offer to an advertiser to optimize an ad campaign of the advertiser that includes one or more digital ads to be placed on a webpage or presented in any other manner to any sense or senses of the user. In one implementation, the digital ads may be textual offers, graphical ads, graphical ads based on textual offers, video ads, or any other type of online media for placement on a webpage.

The ad provider or other third-party entity may extend the offer to the advertiser white the advertiser is interacting with an ad campaign management system of the ad provider or the ad provider or other third-party entity may extend the offer using other communication means such as email, text messages, letters, faxes, and/or phone calls. The ad provider or third-party entity may include a guarantee in the offer that the performance of the optimized ad campaign will be at least as good as what the performance of the ad campaign would have been if the ad campaign was not optimized.

At step 304, the advertiser accepts the offer extended by the ad provider or third-party entity. In one implementation, the advertiser accepts the offer by choosing to optimize the ad campaign while interacting with the ad campaign management system of the ad provider. At step 306, the advertiser indicates which performance metrics associated with the ad campaign that the advertiser would like optimized. For example, the advertiser may indicate that they would like to lower a cost-per-click (“CPC”) associated with the ad campaign without reducing a number of click-throughs (“clicks”) per day; to increase a number of clicks per day without raising an overall cost per day; to increase sales revenue per day without increasing cost per sale; or to improve any other specified performance metric or combination of performance metrics without exceeding specified limits placed on ad campaign parameters such as an ad campaign budget. The chosen metric or metrics become the agreed criteria by which performance improvement will be measured below at step 318. In another implementation, the ad provider in step 302 could suggest metrics to optimize, and if at step 304, the advertiser accepted those suggestions, the advertiser could bypass step 306. In yet another implementation, step 306 could precede step 302 in which case the choices made by the advertiser in step 306 would allow the offer in step 302 to address the advertiser's goals more specifically.

At step 308, the ad campaign optimizer creates a copy of the ad campaign, and at step 310, the ad campaign optimizer changes one or more parameters of the copy of the ad campaign in an attempt to improve the advertiser-specified metric of ad campaign performance. The copy of the ad campaign is thereafter regarded as the optimized ad campaign. However, it will be appreciated that in other implementations, the ad campaign optimizer may change parameters of the original ad campaign and leave the copy of the ad campaign as the unoptimized ad campaign. The campaign parameters that the ad campaign optimizer may change may determine which digital ad is presented in any given situation, and can involve one or more targeting options, such as targeting by demographics, geography, behavior, technographics or context. Examples of ad campaign optimizers are disclosed in U.S. patent application Ser. No. 11/607,292, filed Nov. 30, 2006 and assigned to Yahoo! Inc., the entirety of which is hereby incorporated by reference.

At step 312, the ad campaign optimizer allocates a first portion of ad campaign activations (opportunities for the ad campaign to contend for a specific ad placement) to the optimized ad campaign and allocates a second portion of ad campaign activations to the unoptimized ad campaign. The ad campaign optimizer initially allocates a small portion of ad campaign activations, such as 10% for a small ad campaign or 1% for a large ad campaign, to the optimized ad campaign and allocates the remaining portion of ad campaign activations to the unoptimized ad campaign. Then, as discussed in more detail below, as the ad campaign optimizer determines that the optimized ad campaign performs better than the unoptimized ad campaign, the ad campaign optimizer increases the portion of ad campaign activations allocated to the optimized ad campaign and reduces the portion of ad campaign activations allocated to the unoptimized ad campaign.

The ad campaign management system runs the ad campaign to serve digital ads randomly from both the optimized ad campaign and the unoptimized ad campaign at step 314. In one implementation, if 10% of the activations are allocated to the optimized ad campaign, whenever a digital ad is to be served, a pseudo-random number is chosen between 0.0 and 100.0, and only if the chosen number is less than 10.0 is the optimized ad campaign activated. The ad campaign optimizer may choose the pseudo-random number each time a digital ad is to be served, or the ad campaign optimizer may choose the pseudo-random number to determine which ad campaign to serve digital ads from for a defined period of time. For example, continuing with the example above, the ad campaign optimizer may choose a pseudo-random number each hour, and if the chosen number is less than 10.0, the optimized ad campaign is activated for the next hour.

In other implementations, if 10% of the activations are allocated to the optimized ad campaign, the ad campaign management system runs the ad campaign to serve digital ads randomly from both the optimized ad campaign and the unoptimized ad campaign until 10% of the ad campaign daily budget has been spent on the optimized ad campaign. After 10% of the ad campaign daily budget has been spent on the optimized ad campaign, the ad provider no longer serves digital ads from the optimized ad campaign.

In yet another implementation, if 10% of the activations are allocated to the optimized ad campaign, for a defined time period such as a ten hour period, the ad campaign management system runs the ad campaign to serve digital ads from the unoptimized ad campaign only for nine of the ten hour period, and to serve digital ads from the optimized ad campaign only for one hour of the ten hour period. In other implementations, other allocation schemes that allow for valid statistical analysis may be used to control the number of digital ads served from the optimized or unoptimized ad campaigns based on the percentage of ad campaign activations associated with optimized or unoptimized ad campaigns.

The website provider, ad provider, and/or ad campaign management system monitor the performance of the optimized ad campaign and the unoptimized ad campaign at step 316. To monitor the performance of the ad campaigns, the website provider, ad provider, and/or ad campaign management system may monitor metrics such as a click-through rate associated with digital ads, a number of clicks associated with digital ads, a demographic of Internet user clicking on digital ads, a cost to an advertiser associated with a digital ad, “conversions” associated with digital ads, or any other metric associated with a digital ad of an ad campaign that may be helpful in determining a performance the ad campaign.

At step 318, the ad campaign optimizer determines whether the performance of the optimized ad campaign is at least equal to the performance of the unoptimized ad campaign. For example, if at step 306 the advertiser indicated that they would like to lower a CPC associated with optimized digital ads without reducing a number of clicks on the optimized digital ads per day, at step 318 the ad campaign optimizer determines whether a number of clicks per day associated with digital ads of the optimized ad campaign is proportionally at least equal to a number of clicks per day associated with the digital ads of the unoptimized ad campaign and that a CPC associated with digital ads of the optimized ad campaign is no greater than a CPC associated with the digital ads of the unoptimized ad campaign.

After the ad campaign optimizer has collected enough data to detect a statistically significant difference in performance between the optimized ad campaign and the unoptimized ad campaign, if the ad campaign optimizer determines the optimized ad campaign is performing at least as well as the unoptimized ad campaign (branch 320), the ad campaign optimizer increases the portion of ad campaign activations allocated to the optimized ad campaign and decreases the portion of ad campaign activations allocated to the unoptimized ad campaign at step 322.

It will be appreciated that in some implementations, if the ad provider does not typically serve enough digital ads from the ad campaign at issue to reach a sample size allowing detection of a statistically significant difference in performance between the ad campaign and an optimized variant of the ad campaign within a reasonable (to the advertiser) amount of time, then, an ad provider or third-party entity may not offer to optimize the ad campaign. However, in other implementations, a difference in performance between an ad campaign and an optimized variant of the ad campaign may be measured after a fixed amount of time (e.g., two weeks) and the lack of statistical significance ignored because the financial risk to the ad provider for such a small campaign may be minimal.

In one implementation, the allocation of ad campaign activations is increased at step 322 by the same or a similar percentage of ad campaign activations as initially allocated to the optimized ad campaign. For example, if an optimized ad campaign is initially allocated 10% of the ad campaign activations, at step 322 the ad campaign optimizer increases the allocation of ad campaign activations of the optimized ad campaign to 20%. In another implementation, at step 322 the allocation of ad campaign activations is adjusted based on actuarial calculations that seek to maximize a probabilistically expected net income to the ad provider based on estimated probabilities of various favorable and unfavorable outcomes and the cost or profit that would arise from each such outcome.

At step 324, the advertiser compensates the ad provider, or third-party entity providing ad campaign optimization, based on the performance of the optimized ad campaign. For example, if an ad provider offers to lower a CPC associated an optimized ad campaign, the advertiser may compensate the ad provider based on a percentage of the cost reduction for the optimized ad campaign; if the ad provider offers to increase a number of clicks associated with an optimized ad campaign per day without increasing a cost to the advertiser for the optimized ad campaign per day, the advertiser may compensate the ad provider by foregoing a portion of daily exposures/activations; or if the ad provider offers to improve conversions associated with an optimized ad campaign, the advertiser may agree to let the ad provider use or publish that conversion data in a manner likely to enhance the ad provider's business.

In some implementations, at step 325, the advertiser may deactivate the unoptimized ad campaign in favor of the optimized ad campaign. If an advertiser does not deactivate the unoptimized ad campaign (branch 327), the method loops to step 314 and the above-described process is repeated. However, if an advertiser deactivates the unoptimized ad campaign (branch 329), the method ends. It should be appreciated that once the unoptimized ad campaign is disabled, the advertiser may no longer compensate the ad provider or third-party entity providing optimization for the difference in performance between an optimized ad campaign and an unoptimized ad campaign. For this reason, an ad provider or third-party entity providing optimization may take actions such as charging the advertiser a fee for deactivating the unoptimized ad campaign or prohibiting the advertiser from deactivating the unoptimized ad campaign for a period of time.

Alternatively, after the ad campaign optimizer has collected enough data to detect a statistically significant difference in performance between the optimized ad campaign and the unoptimized ad campaign, if the ad campaign optimizer determines at step 318 that the optimized ad campaign is not performing at least as well as the unoptimized ad campaign (branch 326), the ad campaign optimizer reduces the portion of ad campaign activations allocated to the optimized ad campaign and increases the portion of ad campaign activations allocated to the unoptimized ad campaign at step 328. If the portion of ad campaign activations allocated to the optimized ad campaign is reduced to zero, then the optimizer may deactivate the optimized campaign. In some implementations, after deactivating a poorly performing optimized campaign, the optimizer restarts the process at an earlier step such as 302 or 308 but this time optimizes the campaign by a different algorithm or method. As described above, it will be appreciated that in some implementations, if the ad provider does not typically serve enough digital ads from the ad campaign at issue to reach a sample size allowing detection of a statistically significant difference in performance between the ad campaign and an optimized variant of the ad campaign within a reasonable (to the advertiser) amount of time, then, an ad provider or third-party entity may not offer to optimize the ad campaign. However, in other implementations, a difference in performance between an ad campaign and an optimized variant of the ad campaign may be measured after a fixed amount of time (e.g., two weeks) and the lack of statistical significance ignored because the financial risk to the ad provider for such a small campaign may be minimal.

At step 330, the ad provider, or third-party entity providing ad campaign optimization, compensates the advertiser based on the level of performance of the unoptimized ad campaign and the optimized ad campaign. For example, the ad provider may provide fee discounts or free exposures in quantities sufficient to offset the lower performance of the optimized campaign.

At step 332, the ad campaign optimizer determines whether the optimized ad campaign has been deactivated. If the optimized ad campaign has not been deactivated (branch 334), the method loops to step 314 and the above-described process is repeated. However, if the optimized ad campaign has been deactivated (branch 336), the method ends.

While the systems and methods described above have been described with respect to one optimized ad campaign and one unoptimized ad campaign, it should be appreciated that the same systems and methods could be implemented with one unoptimized ad campaign and multiple optimized ad campaigns that are optimized in different ways. In this implementation, initially, a plurality of ad campaign activations would be allocated to the unoptimized ad campaign and a small percentage of ad campaign activations would be allocated to each optimized ad campaign. As the ad campaign optimizer determines one or more of the optimized ad campaigns are performing better than the unoptimized ad campaign, the ad campaign optimizer increases the allocation of ad campaign activations to one or more optimized ad campaigns that are performing well and decreases the allocation of ad campaign activations to the unoptimized ad campaign and/or to other optimized ad campaigns.

While the systems and methods described above have been described with respect to digital ads placed on a webpage, it should be appreciated that the same systems and methods could be implemented with respect to ads of any kind appearing within any communication medium for which contemporaneous variants of an ad campaign can be distributed and for which the relative or absolute performance of those variants can be measured. For example, digital ads could be placed within an email or text message or within a PDF (portable document format) document distributed through the Internet; or through a wireless network to a cellular telephone, smartphone, PDA, e-book (electronic book), wristwatch, or other mobile device; or through satellite, cable, or wireless (“air”) broadcast to a television, radio, game console or other stationary device. As a further example, print ads could be distributed through flyers, magazines or newspapers wherein different recipients would receive ads chosen by an optimized or unoptimized campaign variant and performance would be measured by such techniques as counting telephone calls to toll-free ordering numbers that differ between campaign variants.

Further, while the systems and methods described above have been described with respect to advertising, it should be appreciated that the same systems and methods for providing guaranteed optimization could be applied to other business tools. For example, an online customer relationship management system (“CRM system”) may provide businesses and charities (“clients”) the ability to send offers, catalogs, and such (a business campaign) to prospective customers or donors by email and/or physical mailings. The CRM system may provide the ability for a client to supply parameters associated with a campaign such as demographic information associated with target customers; a frequency and timing of mailings; a percentage of mailings associated with particular offers such as new products, frequent flier miles, discounts, matching gifts, two-for-one sales, no sales tax, free shipping, or free trial; and a tagline such as an email subject line or a mailing envelope teaser. Business campaign parameters and taglines would be similar for a charity, but offers would typically be of a different nature, for example, goods such as wristbands or intangibles such as inclusion in a donor list.

The CRM mailing provider may charge a fixed fee per mailing and monitor customer actions associated with mailings such as a number of inquiries received from customers that received a mailing; a number of customers accepting offers associated with a received mailing; and/or a number of customers accepting an offer associated with a mailing that have accepted offers associated with previous mailings.

The CRM mailing provider may offer to optimize a client's mailing and guarantee that the performance of the optimized mailings will be at least equal to the performance of the mailings had the CRM mailing provider not optimized the mailings. The client may accept the offer and provide the CRM mailing provider with information regarding how the client would like their mailing optimized.

When the client accepts the offer, the CRM mailing provider creates an optimized variant of the mailing. The CRM mailing provider then provides a small percentage of customers with the optimized mailing and provides the remaining customers with the unoptimized mailings. The CRM mailing provider monitors the performance of the mailings and determines whether the performance of the optimized mailings is at least as good as the performance of the unoptimized mailings.

When the CRM mailing provider determines the performance of the optimized mailing is at least as good as the performance of the unoptimized mailings, the CRM mailing provider increases the percentage of customers that receive the optimized mailing in the next mailing and decreases the percentage of customers that receive the unoptimized mailing in the next mailing. Additionally, the client may compensate the CRM mailing provider based on the difference in performance between the optimized mailing and the unoptimized mailing.

Alternatively, when the CRM mailing provider determines the performance of the optimized mailing is not at least as good as the performance of the unoptimized mailing, the CRM mailing provider decreases the percentage of customers that receive the optimized mailing in the next mailing and increases the percentage of customers that receive the unoptimized mailing in the next mailing. If the performance of the optimized mailing is below a predetermined threshold, the CRM mailing provider may remove the optimized mailing altogether. Additionally, the CRM mailing provider may compensate the client based on the difference in performance between the optimized mailing and the unoptimized mailing. Accordingly, it should be appreciated that the above-described examples with respect to online advertising and mailings should be regarding as illustrative rather than limiting.

While the systems and methods described above have been described with respect to an ad campaign optimizer that automatically adjusts metrics associated with an optimized ad campaign, it should be appreciated that the same methods for improving the performance of digital ads may be implemented without an ad campaign optimizer that automatically adjusts metrics associated with an optimized ad campaign. For example, an ad campaign optimizer may suggest changes to metrics associated with an ad campaign to an advertiser via an ad campaign management system or other communication means. The ad campaign optimizer may then provide the advertiser the ability to select one or more of the suggested changes that the advertiser would like to implement, or allow the advertiser to delegate the decision of which of the one or more suggested changes to implement to the ad campaign optimizer, which may implement any, or all, of the suggested changes in sequence or in parallel, separately or in combination.

As described above, the ad campaign optimizer runs the optimized variant of the ad campaign with an initial allocation of ad campaign activations that has been set by the advertiser or the ad campaign optimizer, and runs the original ad campaign with the remaining allocation of ad campaign activations. The ad campaign optimizer monitors the performance of the optimized and unoptimized ad campaigns, and periodically reports the performance of the optimized and unoptimized ad campaigns to the advertiser or the ad campaign optimizer so that the advertiser or ad campaign optimizer may further adjust the metrics associated with the optimized ad campaign and/or adjust the allocation of ad campaign activations associated with the optimized and unoptimized ad campaigns.

In another example, an ad campaign optimizer may alert an advertiser to exceptionally performing placements. The ad campaign optimizer may then provide the advertiser the ability to select whether to create an optimized variant of the ad campaign with budget shifted from placements that are performing poorly to the placements that are performing exceptionally well, and run the optimized ad campaign with an initial allocation of ad campaign activations and run the original ad campaign with the remaining allocation of ad campaign activations. Similar to the methods described above, the ad campaign optimizer monitors the performance of the optimized and unoptimized ad campaigns, and periodically reports the performance of the optimized and unoptimized ad campaigns so that the advertiser or the ad campaign optimizer may further adjust the allocation of ad campaign activations associated with the optimized and unoptimized ad campaigns.

In yet another example, an ad campaign optimizer alerts an advertiser to placements that the ad campaign optimizer predicts will perform well. The ad campaign optimizer may then provide the advertiser the ability to select whether to create an optimized variant of the ad campaign with budget shifted from placements that the ad campaign optimizer predicts will perform poorly to placements that the ad campaign optimizer predicts will perform well, and run the optimized ad campaign with an initial allocation of ad campaign activations and run the original ad campaign with the remaining allocation of ad campaign activations. Similar to the methods described above, the ad campaign optimizer monitors the performance of the optimized and unoptimized ad campaigns, and periodically reports the performance of the optimized and unoptimized ad campaigns so that the advertiser or the ad campaign optimizer may further adjust the allocation of ad campaign activations associated with the optimized and unoptimized ad campaigns.

In yet another example, an ad campaign optimizer alerts an advertiser to placements that have performed well in similar ad campaigns. The ad campaign optimizer may then provide the advertiser the ability to select whether to create an optimized variant of the ad campaign with budget shifted from placements that have not performed well in similar ad campaigns to placements that have performed well in similar ad campaigns, and run the optimized ad campaign with an initial allocation of ad campaign activations and run the original ad campaign with the remaining allocation of ad campaign activations. Similar to the methods described above, the ad campaign optimizer monitors the performance of the optimized and unoptimized ad campaigns, and periodically reports the performance of the optimized and unoptimized ad campaigns so that the advertiser or the ad campaign optimizer may further adjust the allocation of ad campaign activations associated with the optimized and unoptimized ad campaigns.

FIGS. 1-3 describe systems and methods for improving the performance of digital ads. To encourage advertisers to utilize an ad campaign optimizer, an ad provider or other third-party entity may extend an offer to advertisers that guarantees an ad campaign optimized by an ad campaign optimizer will perform at least as well as an unoptimized ad campaign. In response to an advertiser accepting the offer, the ad campaign optimizer automatically establishes an unoptimized version of an ad campaign and one or more optimized versions of the ad campaign. The ad provider serves digital ads from both the unoptimized ad campaign and the one or more optimized ad campaigns to Internet users, and monitors the performance of the ad campaigns.

Based on the performance of the ad campaigns, the ad campaign optimizer may automatically adjust a portion of ad campaign activations allocated to the unoptimized ad campaign and the one or more optimized ad campaigns. Additionally, when an optimized ad campaign performs better than an unoptimized ad campaign, the advertiser may compensate the ad provider or third-party entity based on a difference in performance between the optimized and the unoptimized ad campaign. If the optimized ad campaign does not perform as well as the unoptimized ad campaign, the ad provider or third-party entity may compensate the advertiser based on a difference in performance between the optimized and the unoptimized ad campaign.

It is intended that the foregoing detailed description be regarded as illustrative rather than limiting, and that it be understood that it is the following claims, including all equivalents, that are intended to define the spirit and scope of this invention.

1. A method for optimizing performance of an ad campaign, the method comprising;
extending an offer to an advertiser to optimize an ad campaign, the offer providing that an optimized version of the ad campaign performs at least as well as an unoptimized version of the ad campaign;
automatically creating the optimized version of the ad campaign after receiving an acceptance of the offer;
monitoring a performance of the optimized ad campaign and a performance of the unoptimized ad campaign; and
automatically adjusting a portion of ad campaign activations allocated to the optimized ad campaign and a portion of ad campaign activations allocated to the unoptimized ad campaign based on the monitored performance of the optimized ad campaign and the monitored performance of the unoptimized ad campaign.

2. The method of claim 1, further comprising:
receiving the acceptance of the offer; and
receiving an indication of a performance metric associated with the ad campaign to be optimized.

3. The method of claim 2, wherein the indication of a performance metric to be optimized comprises at least one of:
lowering a cost-per-click associated with digital ads of the optimized ad campaign without reducing a number of click-throughs on the digital ads of the optimized ad campaign per day;
increasing a number of click-throughs per day on the digital ads of the optimized ad campaign without raising an overall cost to the advertiser; or
improving conversions associated with digital ads of the optimized ad campaign.

4. The method of claim 1t further comprising:
compensating the advertiser upon a determination that the optimized ad campaign is not performing as well as the unoptimized ad campaign.

5. The method of claim 1, further comprising:
serving one or more digital ads from the optimized ad campaign and one or more digital ads from the unoptimized ad campaign to a plurality of users.

6. The method of claim 1, wherein automatically adjusting a portion of ad campaign activations allocated to the optimized ad campaign and a portion of ad campaign activations allocated to the unoptimized ad campaign comprises:
increasing a portion of ad campaign activations allocated to the optimized ad campaign and decreasing a portion of ad campaign activations allocated to the unoptimized ad campaign upon a determination that the optimized ad campaign is performing at least as well as the unoptimized ad campaign.

7. The method of claim 1, wherein automatically adjusting a portion of ad campaign activations allocated to the optimized ad campaign and a portion of ad campaign activations allocated to the unoptimized ad campaign comprises:
decreasing a portion of ad campaign activations allocated to the optimized ad campaign and increasing a portion of ad campaign activations allocated to the unoptimized ad campaign upon a determination that the optimized ad campaign is not performing at least as well as the unoptimized ad campaign.

8. The method of claim 7, wherein decreasing a portion of ad campaign activations allocated to the optimized ad campaign comprises not allocating a portion of ad campaign activations to the optimized ad campaign.

9. A computer-readable storage medium comprising a set of instructions for optimizing performance of an ad campaign, the set of instructions operative to direct a processor to perform acts of:
extending an offer to an advertiser to optimize an ad campaign, the offer providing that an optimized version of the ad campaign performs at least as well as an unoptimized version of the ad campaign;
automatically creating the optimized version of the ad campaign after receiving an acceptance of the offer;
monitoring a performance of the optimized ad campaign and a performance of the unoptimized ad campaign; and
automatically adjusting a portion of ad campaign activations allocated to the optimized ad campaign and a portion of ad campaign activations allocated to the unoptimized ad campaign based on the monitored performance of the optimized ad campaign and the monitored performance of the unoptimized ad campaign.

10. The computer-readable storage medium of claim 9, further comprising a set of instructions to direct a processor to perform acts of:
receiving the acceptance of the offer; and
receiving an indication of a performance metric associated with the ad campaign to be optimized.

11. The computer-readable storage medium of claim 9, further comprising a set of instructions to direct a processor to perform acts of:
compensating the advertiser upon a determination that the optimized ad campaign is not performing as well as the unoptimized ad campaign.

12. The computer-readable storage medium of claim 9, further comprising a set of instructions to direct a processor to perform acts of:
serving one or more digital ads from the optimized ad campaign and one or more digital ads from the unoptimized ad campaign to a plurality of users.

13. The computer-readable storage medium of claim 9, wherein automatically adjusting a portion of ad campaign activations allocated to the optimized ad campaign and a portion of ad campaign activations allocated to the unoptimized ad campaign comprises:
increasing a portion of ad campaign activations allocated to the optimized ad campaign and decreasing a portion of ad campaign activations allocated to the unoptimized ad campaign upon a determination that the optimized ad campaign is performing at least as well as the unoptimized ad campaign.

14. The computer-readable storage medium of claim 9, wherein automatically adjusting a portion of ad campaign activations allocated to the optimized ad campaign and a portion of ad campaign activations allocated to the unoptimized ad campaign comprises:
decreasing a portion of ad campaign activations allocated to the optimized ad campaign and increasing a portion of ad campaign activations allocated to the unoptimized ad campaign upon a determination that the optimized ad campaign is not performing at least as well as the unoptimized ad campaign.

15. A system for optimizing performance of an ad campaign, the system comprising:
an ad campaign optimizer operative to:
automatically create an optimized version of an ad campaign in response to an acceptance of an offer to optimize the ad campaign, the offer providing that the optimized version of the ad campaign performs at least as well as an unoptimized version of the ad campaign;
monitor a performance of the optimized ad campaign and a performance of the unoptimized ad campaign; and
automatically adjust a portion of ad campaign activations allocated to the optimized ad campaign and a portion of ad campaign activations allocated to the unoptimized ad campaign based on the monitored performance of the optimized ad campaign and the monitored performance of the unoptimized ad campaign.

16. The system of claim 15, further comprising:
an ad campaign management system in communication with the ad campaign optimizer, the ad campaign management system operative to receive the acceptance of the offer and to receive an indication of a performance metric associated with the ad campaign to be optimized.

17. The system of claim 16, further comprising:
an ad provider in communication with the ad campaign optimizer and the ad campaign management system, the ad provider operative to serve one or more digital ads from the optimized ad campaign and one or more digital ads from the unoptimized ad campaign to a plurality of users.

18. The system of claim 15, wherein to automatically adjust a portion of ad campaign activations allocated to the optimized ad campaign and a portion of ad campaign activations allocated to the unoptimized ad campaign, the ad campaign optimizer is further operative to:
increase a portion of ad campaign activations allocated to the optimized ad campaign and decrease a portion of ad campaign activations allocated to the unoptimized ad campaign upon a determination that the optimized ad campaign is performing at least as well as the unoptimized ad campaign.

19. The system of claim 15, wherein to automatically adjust a portion of ad campaign activations allocated to the optimized ad campaign and a portion of ad campaign activations allocated to the unoptimized ad campaign, the ad campaign optimizer is further operative to:
decrease a portion of ad campaign activations allocated to the optimized ad campaign and increase a portion of ad campaign activations allocated to the unoptimized ad campaign upon a determination that the optimized ad campaign is not performing at least as well as the unoptimized ad campaign.

20. A method for optimizing performance of a business campaign, the method comprising;
extending an offer to a client to optimize a business campaign, the offer comprising a guarantee that an optimized version of the business campaign performs at least as well as an unoptimized version of the business campaign;
automatically creating the optimized version of the business campaign after receiving an acceptance of the offer;
monitoring a performance of the optimized business campaign and a performance of the unoptimized business campaign; and
automatically adjusting a portion of a budget allocated to the optimized business campaign and a portion of the budget allocated to the unoptimized business campaign based on the monitored performance of the optimized business campaign and the monitored performance of the unoptimized business campaign.

21. A method for optimizing performance of an ad campaign, the method comprising:
extending an offer to an advertiser to optimize an ad campaign;
automatically creating the optimized version of the ad campaign after receiving an acceptance of the offer;
monitoring a performance of the optimized ad campaign and a performance of the unoptimized ad campaign; and
adjusting a portion of ad campaign activations allocated to the optimized ad campaign and a portion of ad campaign activations allocated to the unoptimized ad campaign based on the monitored performance of the optimized ad campaign and the monitored performance of the unoptimized ad campaign.

22. The method of claim 21, wherein the offer comprises a guarantee that an optimized version of the ad campaign performs at least as well as the unoptimized version of the ad campaign.

23. The method of claim 21, wherein the portion of the ad campaign activations allocated to the optimized ad campaign and the portion of ad campaign activations allocated to the unoptimized ad campaign is adjusted automatically.
